(19) United States
(12) Patent Application Publication
(10) Pub. No.: US 2025/0055028 A1
(43) Pub. Date: Feb. 13, 2025

(54) FLEXIBLE, WASHABLE, RECHARGEABLE SOLID-STATE THREAD BATTERY

(71) Applicant: Battelle Memorial Institute, Columbus, OH (US)

(72) Inventors: Matthew COLACHIS, Columbus, OH (US); Steven M. RISSER, Reynoldsburg, OH (US); Katherine PALMER, Galloway, OH (US)

(21) Appl. No.: 18/447,385

(22) Filed: Aug. 10, 2023

Related U.S. Application Data
(60) Provisional application No. 63/371,896, filed on Aug. 19, 2022.

(51) Int. Cl. H01M 10/0565; H01M 4/36; H01M 4/38; H01M 4/485; H01M 4/583; H01M 50/107

(52) U.S. Cl. CPC H01M 10/0565; H01M 4/366; H01M 4/38; H01M 4/485; H01M 4/583; H01M 50/107; H01M 2004/027; H01M 2004/028; H01M 2300/0082

(57) ABSTRACT

A solid-state battery includes a cathode; an anode; and a solid-state electrolyte layer disposed between the cathode and the anode, where the cathode, the anode, and the solid-state electrolyte layer are comprised of flexible materials to form a thread.

### CROSS-REFERENCE TO RELATED APPLICATIONS

The present application claims the benefit of the filing date of U.S. Provisional Application Ser. No. 63/371,896, filed Aug. 19, 2022, the entire teachings of which application is hereby incorporated herein by reference.

### TECHNICAL FIELD

The present application relates generally to solid-state batteries and, more particularly, to a flexible, washable, rechargeable solid-state thread battery.

### BACKGROUND

Batteries for wearable applications typically utilize technologies such as lithium polymer. A lithium polymer battery, or more correctly lithium-ion polymer battery (abbreviated as LiPo, LIP, Li-poly, lithium-poly, and others), is a rechargeable battery of lithium-ion technology using a polymer gel electrolyte instead of a liquid electrolyte. These batteries provide higher specific energy than other lithium battery types and are used in applications where weight is a critical feature, such as mobile devices, radio-controlled aircraft, and some electric vehicles.

A solid-state battery is a battery technology that uses solid electrodes and a solid electrolyte, instead of the liquid or polymer gel electrolytes found in lithium-ion or lithium polymer batteries.

### BRIEF DESCRIPTION OF THE DRAWINGS

Reference should be made to the following detailed description which should be read in conjunction with the following figures, wherein like numerals represent like parts.

FIG. 1 is an illustrative example of one possible method to fabricate a solid-state battery (SSB), consistent with the present disclosure.

FIG. 2 is an example of a solid-state thread battery constructed of concentric anode and cathode layers, consistent with the present disclosure.

FIG. 3 is an example of a solid-state thread battery constructed of separate anode and cathode yarns, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

The demand for flexible, washable, and wearable smart textiles is rapidly increasing. The wearables and electronic textiles (e-textiles) market is currently experiencing rapid growth. When it comes to wearables, there is a large setback with the power source to operate these devices. Being able to fully integrate a battery that is washable, flexible, and non-detectable into one of these garments that can power the entire system is highly desirable. There are many challenges with the current state of the art lithium-ion liquid or gel electrolytic batteries.

State of the art lithium-ion liquid electrolytic batteries have many drawbacks. Some of these drawbacks include these batteries contain a volatile and flammable liquid electrolyte, which can overheat and explode if charged too quickly, they have a short lifetime (they can fail after less than 1000 charge/discharge cycles), and they underperform in extreme temperatures. Many of these drawbacks are associated with the use of a liquid electrolyte. There exists a need to overcome the drawbacks of current state-of-the-art lithium-ion liquid electrolyte batteries, and a need for conformable, flexible, and wearable batteries for smart textiles and garments.

Solid-state batteries use a solid electrolyte, which is more efficient than normal lithium-ion batteries, increases the safety in small sizes, has the potential for higher energy density and faster charging, provides long-lasting energy storage for off-grid applications, and is easier to manufacture. Solid state batteries are capable of delivering 2.5 times more energy density than normal lithium-ion batteries, which allows for a much smaller and lighter battery.

Disclosed herein is a highly integrated, flexible, washable, and rechargeable solid-state thread battery that solves these problems. The rechargeable solid-state thread battery is easily able to fit almost any form factor in the wearable textiles or devices realm. Existing wearable battery technologies have the electrolyte in a liquid or gel state. The present disclosure has the electrolyte as a solid, which eliminates the problem of electrolyte leakage, thereby allowing for increased safety in small sizes, higher energy density, provides faster charging and long-lasting energy storage for off-grid applications, and is easier to manufacture.

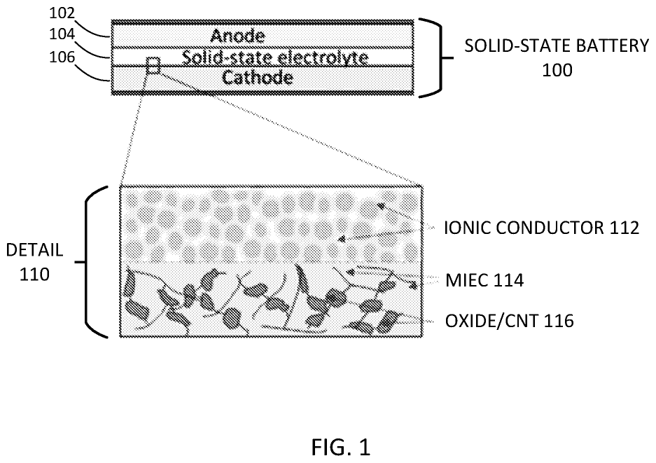

FIG. 1 is an illustrative example of one possible method to fabricate a solid-state battery (SSB), consistent with the present disclosure. FIG. 1 represents only one example of a method to fabricate an SSB. Many other methods are possible, as would be known to a person of skill in the art. In the illustrated example embodiment of FIG. 1, an SSB contains the following components: an anode 102 composed of graphitic carbon embedded in a solid mixed ionic-electronic conductive (MIEC) electrolyte; a cathode 106 comprised of mixed metal oxide intercalated (XaYb)Oc nanoparticles grown directly onto carbon nanotubes (CNTs) that are embedded in the solid MIEC electrolyte; and a solid-state electrolyte 104 between anode 102 and cathode 106 comprised of the ionic conductor used in the MIEC, without CNTs that provide electrical conductivity.

FIG. 1 includes a detail 110 of the junction between the solid-state electrolyte and the cathode. In the detail 110 of FIG. 1, the solid-state electrolyte is composed of the same ionic conductor 112, disposed on stimuli-responsive particles. The cathode 106 is composed of metal oxide nanoparticles, e.g., oxide/CNT 116, bound together by the MIEC material 114.

The example method illustrated in FIG. 1 maintains the interface function between the charge storage and charge transport materials in solid-state batteries (SSB). This method uses several approaches to mitigate the effects of the morphology changes that occur at the electrode/electrolyte interface, maintaining battery performance for >1000 cycles, compared to the <50 cycles for current SSBs. This method also accelerates charge throughout the SSB and increases energy density to greater than 400 watt-hours per kilogram (Wh/kg), compared to current SSBs which are typically less than 300 Wh/kg, by minimizing non-active materials incorporated into the electrodes.

This method builds upon several innovations to provide a flexible framework that responsively stabilizes solid-state batteries through rationale interface design. First, these innovations include new 3D computational methods based on deterministic and statistical algorithms which enable optimizing materials at the nanoscale and predicting the macro-level parameters.

Second, in-situ synthesis of metal oxides with CNTs yields oxide nanoparticles covalently bound to the CNTs with enhanced cycling stability. These oxide/CNT materials do not require conductive additives in electrode formulations, increasing the energy density.

Third, incorporation of elastic MIECs with total conductivity greater than 1000 milliSiemens per centimeter (mS/cm) and Na+ conductivity much greater than 10 mS/cm without incorporation of liquid electrolytes. The benefit of these organic materials is that they can be tailored to provide high electronic and ionic conductivity and serve as an electrically resistive layer between the electrodes.

Fourth, the SSB is fabricated using additive manufacturing to create a smooth transition between the anode/cathode layers and the electrically insulating electrolyte layer. This has the advantage of eliminating the apparent interface between electrodes and electrolyte, and also allows the formation of macroscopic structures within the electrode and the separator that enhance response to the electrochemical gradients within the materials.

These approaches mitigate the effects of the morphology changes that occur at the electrode/electrolyte interface in two ways. First, the swelling and contraction of electrode layers is used as charge is injected or removed from the metal oxides or carbon. Within the electrode, regions that are electrically isolated will feel reduced mechanical stress. Since the solid-state electrolyte is more compliant than the metal oxide nanoparticles, the electrolyte around these disconnected regions will become strained and will re-establish connections to the MIEC. Second, if an electrode region is ionically isolated from the opposite electrode, the swelling or shrinking of the other regions of the electrode will also result in an increase in pressure from the central electrolyte region. The compliance of this region will act to distort the compliant electrolyte, bridging any gaps and restoring the interface.

This method creates a transformational change in SSBs, especially for dismounted and vehicle applications, where increased energy density and cycle life are critical.

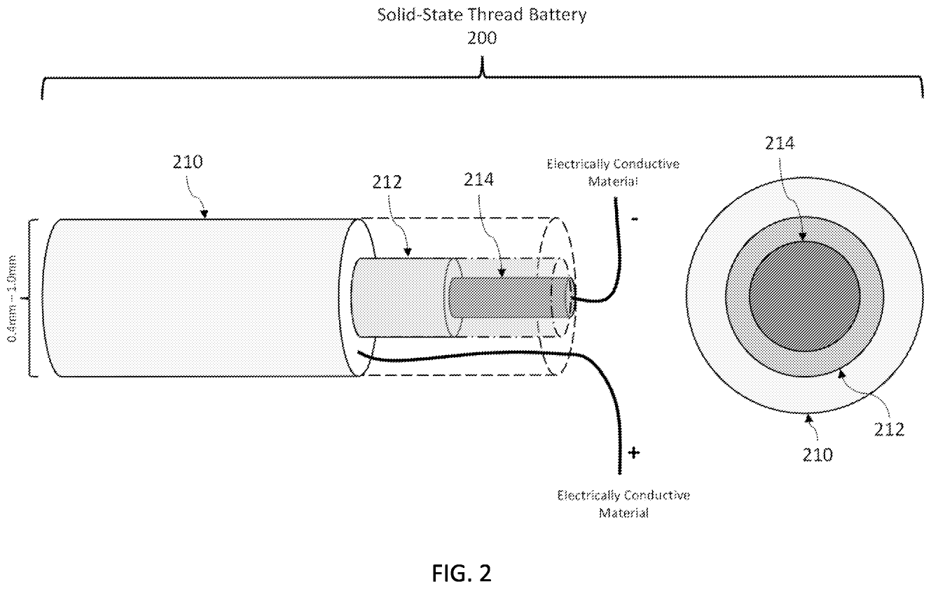

FIG. 2 is an example of a solid-state thread battery constructed of an anode and a cathode disposed in concentric layers, consistent with the present disclosure. The example illustrated in FIG. 2 is a flexible, washable, and rechargeable solid-state thread battery. In the example of FIG. 2, the diameter may be in the range of 0.4 millimeters (mm)-1.0 mm, but in other examples, e.g., incorporation into composite structures or in less flexible applications, the range may be greater, for example, in the range of 0.4 mm to 5.0 mm. In the example of FIG. 2, a solid-state electrolyte layer may be constructed using lithium based hyaluronic acid (HA) and nitrile butane rubber (NBR), although other materials may be used as would be known by a person of skill in the art. This solid-state electrolyte is sandwiched between a flexible cathode and a flexible anode. The anode material may be fabricated with, but is not limited to, graphitic carbon embedded in a solid MIEC electrolyte, graphite and LiNi0.6Co0.2Mn0.2O2, stainless steel yarn, etc. The cathode material may be fabricated with, but is not limited to, mixed metal oxides intercalated (XaYb)Oc nanoparticles grown directly onto single walled carbon nanotube (SWNT) that is embedded in the solid MIEC electrolyte. The example solid-state thread battery illustrated in FIG. 2 is encased in one cylinder containing the anode and the cathode separated by a solid-state electrolyte material. Copper wire or CNT threads are inserted in the cathode and the anode to serve as the current collector.

In the example illustrated in FIG. 2, cathode 210 may be composed of mixed metal oxide intercalated (XaYb)Oc nanoparticles grown directly onto CNTs that are embedded in the solid MIEC electrolyte. Solid-state electrolyte 212 may be an ionic conductor used in the MIEC, without CNTs that provide electrical conductivity. In some embodiments the ionic conductor may be Li⁺ based, while in other embodiments the ionic conductor may be other materials, such as sodium or magnesium. Anode 214 is graphitic carbon embedded in the solid MIEC electrolyte.

In the example of FIG. 2, cathode 210 and anode 214 may be any suitable electrically conductive material, as would be known to a person of skill in the art. Some example materials include, but are not limited to, CNT fiber, copper, palladium, etc.

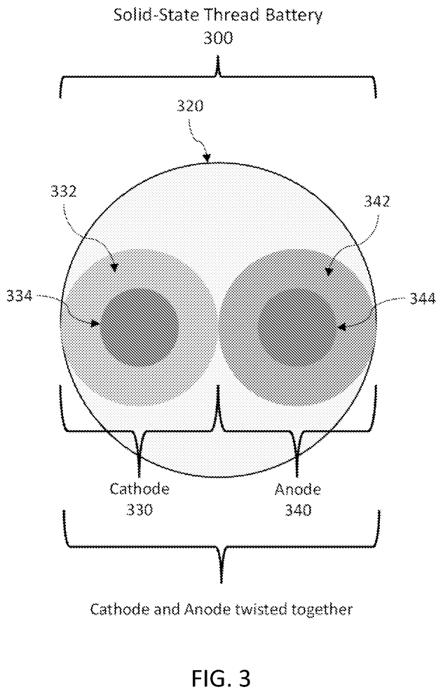

FIG. 3 is an example of a solid-state thread battery constructed of separate anode and cathode yarns, consistent with the present disclosure. The example of FIG. 3 is similar to the example of FIG. 2 above, however in FIG. 3 the anode and the cathode are individual cylinders encased in a larger cylindrical solid-state electrolyte material. In some embodiments, the anode and the cathode cylinders may be twisted together along the length of the cylinder, similar to the construction of a twisted-pair or Twinax cable. Copper wire or CNT threads may be inserted in the cathode and the anode to serve as the current collector.

In the example illustrated in FIG. 3, cathode 330 may be composed of a CNT yarn core 334 surrounded by a manganese dioxide (MnO₂) coated CNT yarn 332. Likewise, anode 340 may be composed of a CNT yarn core 342 surrounded by a zinc (Zn) coated CNT yarn 344.

In the example of FIG. 3, the anode and the cathode may be individual cylinders encased in a larger cylindrical solid-state electrolyte material. As in the example of FIG. 2 above, solid-state electrolyte 320 may be an ionic conductor used in the MIEC, without CNTs that provide electrical conductivity. In some embodiments the ionic conductor may be Li⁺ based, while in other embodiments the ionic conductor may be other materials, such as sodium or magnesium.

As in the example of FIG. 2 above, in the example of FIG. 3 the cathode 330 and the anode 340 may be any suitable electrically conductive material, as would be known to a person of skill in the art. Some example materials include, but are not limited to, CNT fiber, copper, palladium, etc.

Although copper is a suitable electrically conductive material, for many intended uses of the solid-state thread battery using a metal conductor has limitations. Many metals such as copper corrode when exposed to the atmosphere, which can affect the usable life of the battery. In addition, for many applications of the solid-state thread battery, such as wearables, metals exhibit limited flexibility, and have durability concerns. In an application such as a wearable, the constant flexing of the wearable item leads to metal fatigue and breakage. For these reasons, CNTs may be used in many applications, since CNTs do not corrode, nor are they subject to fatigue breakage. In some applications, it is desirable to reduce the detectability of the items containing the solid-state thread battery, and CNTs are inherently less detectable than copper or other metals.

In some embodiments, such as the examples of FIGS. 2 and 3 above, the solid-state thread battery may be covered by a coating or outer layer for protection. In many applications, it is desirable for the coating to be suitable for sewing, knitting, weaving, and finishing operations. Therefore, in some embodiments, the coating may be a flexible enamel, e.g., ceramic enamel, nylon, polyester, or other applicable coating as would be known to a person of skill in the art. In some embodiments, the coating may be in the range of 0.1 mm-1 mm thick.

In some embodiments the solid-state thread battery may be woven into a fabric to form an integrated battery within the fabric. In some embodiments the solid-state thread battery may be incorporated into composite structures, e.g., into an aircraft wing surface for deicing, which may allow for the composite structure to be self-powered. In some embodiments, the fabric or structure comprised of the solid-state thread battery may support wireless charging.

According to one aspect of the disclosure there is thus provided a solid-state battery including: a cathode; an anode; and a solid-state electrolyte layer disposed between the cathode and the anode, where the cathode, the anode, and the solid-state electrolyte layer are comprised of flexible materials to form a thread.

According to another aspect of the disclosure there is thus provided a solid-state battery including: a cathode; an anode; and a solid-state electrolyte layer disposed between the cathode and the anode, where the cathode, the anode, and the solid-state electrolyte layer are comprised of flexible materials to form a thread, the cathode and the anode are each disposed in individual cylinders encased in a larger cylindrical solid-state electrolyte material, and the individual cylinders are twisted about each other along a length of the larger cylindrical solid-state electrolyte material.

According to yet another aspect of the disclosure there is thus provided a solid-state battery including: a cathode; an anode; and a solid-state electrolyte layer disposed between the cathode and the anode, where the cathode, the anode, and the solid-state electrolyte layer are comprised of flexible materials to form a thread, and the cathode and the anode are disposed in concentric layers in one cylinder containing the anode and the cathode, the anode and the cathode separated by the solid-state electrolyte layer.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A solid-state battery comprising:
a cathode;
an anode; and
a solid-state electrolyte layer disposed between the cathode and the anode, wherein the cathode, the anode, and the solid-state electrolyte layer are comprised of flexible materials to form a thread.

2. The solid-state battery of claim 1, wherein the anode is comprised of graphitic carbon embedded in a solid mixed ionic-electronic conductive (MIEC) electrolyte.

3. The solid-state battery of claim 1, wherein the cathode is comprised of mixed metal oxide intercalated (XaYb)O_{c} nanoparticles grown directly onto carbon nanotubes (CNTs).

4. The solid-state battery of claim 1, wherein the cathode is comprised of metal oxide nanoparticles bound together by a solid mixed ionic-electronic conductive (MIEC) electrolyte.

5. The solid-state battery of claim 1, wherein the solid-state electrolyte layer is comprised of an ionic conductor used in a solid mixed ionic-electronic conductive (MIEC) electrolyte without CNTs.

6. The solid-state battery of claim 1, wherein the solid-state battery is rechargeable.

7. The solid-state battery of claim 6, wherein the solid-state battery supports wireless charging.

8. The solid-state battery of claim 1, wherein the thread is washable.

9. The solid-state battery of claim 1, wherein the thread has a diameter in a range of 0.4 millimeters (mm) to 5.0 mm.

10. The solid-state battery of claim 1, wherein the solid-state electrolyte layer is constructed using lithium based hyaluronic acidic (HA) and nitrile butane rubber (NBR).

11. The solid-state battery of claim 1, wherein the cathode and the anode are disposed in concentric layers in one cylinder containing the anode and the cathode, the anode and the cathode separated by the solid-state electrolyte layer.

12. The solid-state battery of claim 1, wherein the cathode and the anode are each disposed in individual cylinders encased in a larger cylindrical solid-state electrolyte material.

13. The solid-state battery of claim 12, wherein the individual cylinders are twisted about each other along a length of the larger cylindrical solid-state electrolyte material.

14. The solid-state battery of claim 1, wherein the thread further comprises an outer layer for protection, and the outer layer is selected from the group consisting of a flexible enamel, a ceramic enamel, nylon, and polyester.

15. The solid-state battery of claim 14, wherein the outer layer is suitable for sewing, knitting, weaving, and finishing operations.

16. The solid-state battery of claim 1, wherein the thread is woven into a fabric to form an integrated battery within the fabric.

17. The solid-state battery of claim 1, wherein the thread is incorporated into a composite structure to allow for the composite structure to be self-powered.

18. A solid-state battery comprising:
a cathode;
an anode; and
a solid-state electrolyte layer disposed between the cathode and the anode, wherein:
the cathode, the anode, and the solid-state electrolyte layer are comprised of flexible materials to form a thread,
the cathode and the anode are each disposed in individual cylinders encased in a larger cylindrical solid-state electrolyte material, and
the individual cylinders are twisted about each other along a length of the larger cylindrical solid-state electrolyte material.

19. The solid-state battery of claim 18, wherein the cathode is composed of a first carbon nanotube (CNT) yarn core surrounded by a manganese dioxide (MnO₂) coated CNT yarn, and the anode is composed of a second CNT yarn core surrounded by a zinc (Zn) coated CNT yarn.

20. A solid-state battery comprising:
a cathode;
an anode; and
a solid-state electrolyte layer disposed between the cathode and the anode, wherein:
the cathode, the anode, and the solid-state electrolyte layer are comprised of flexible materials to form a thread, and
the cathode and the anode are disposed in concentric layers in one cylinder containing the anode and the cathode, the anode and the cathode separated by the solid-state electrolyte layer.
